(19) United States
(12) Patent Application Publication
(10) Pub. No.: US 2003/0189591 A1
(43) Pub. Date: Oct. 9, 2003

(54) Terminal for controlling use of a computer

(76) Inventor: Seung-Kee Mo, Seoul (KR)

Correspondence Address: Finnegan, Henderson, Farabow,, Garrett & Dunner, L.L.P., 1300 I Street, N.W., Washington, DC, 20005-3315, US

(21) Appl. No.: 10/183,570

(22) Filed: Jun. 28, 2002

(30) Foreign Application Priority Data
Apr. 4, 2002 (KR) 2002-0018364

(51) Int. Cl. G09G 5/00

(52) U.S. Cl. 345/738

(57) ABSTRACT

A terminal for controlling use of a computer is provided. The terminal operates together with a monitor/control program installed in the computer and comprises a key input receiving means, a data storing means, a flash memory, a processor, a data transmitting/receiving means, and a display means.

### DESCRIPTION OF THE INVENTION

1. Field of the Invention

The present invention relates to a terminal for controlling the use of a computer by operating in conjunction with a monitor/control program installed in the computer.

2. Background of the Invention

Recently, the popularity of computer ownership has risen to a point where a computer is almost a necessity in many households. Coincidentally, the number of people accessing the Internet has also been steadily increasing.

Therefore, the computer, in conjunction with the Internet, has become an important means of providing information to all of the family members within the household. However, many problems have occurred due to the computer and the Internet, because it is difficult to restrict the use of the computer, and the Internet provides the information indiscriminately. As the result, children can be exposed to harmful websites and harmful games without any restriction since many children play games and connect to websites at home without parental supervision.

Conventionally, the method of requesting a password when the computer is turned on or monitoring the use of the computer through an application program has been employed.

As a method of requesting a password when the computer is turned on, a password may be set up in an input/output device of the computer including the Basic Input Output System (BIOS), and if an incorrect password is provided, use of the computer is prohibited. However, this method totally prohibits children's use of the computer rather than only filtering potentially harmful information.

By using prior methods of monitoring the use of the computer through an application program, computer novices who are not accustomed to the computer may have difficulty in operating the application program. Furthermore, monitoring the history of usage (termed herein as the record of usage) of the computer required the use of the computer itself, and could not be monitored independently from the computer.

### SUMMARY OF THE INVENTION

The present invention is devised to resolve the above-mentioned limitations.

An aspect of the present invention is to provide a terminal for controlling the use of the computer that even computer novices can use.

Another aspect of the present invention is to provide a terminal for controlling the use of the computer that controls the children's computer using time, program execution, and website connection.

Another aspect of the present invention is to provide a terminal for controlling the use of the computer by providing control information to a monitor/control program installed in the computer.

Another aspect of the present invention is to provide a terminal for controlling the use of the computer whereby a supervisor can monitor the record of usage of the computer conveniently.

In order to achieve the above-mentioned aspects in accordance with one preferred embodiment of the present invention, there is provided a terminal for controlling use of a computer by operating together with a monitor/control program installed in the computer, comprising a key input receiving means for receiving control information including computer using time information, executable program information, connectable website information which a supervisor inputs; a data storing means for storing log information about record of usage of the computer which is transmitted from the monitor/control program and the control information which the supervisor inputs; a flash memory for storing a program for controlling operation of the terminal; a processor for generating a control information message according to the control information which the supervisor inputs and processing the supervisor's request information and messages transmitted from the monitor/control program; a data transmitting/receiving means for transmitting the control information message to the monitor/control program and receiving the log information about the record of usage of the computer from the monitor/control program; and a display means for displaying information which the supervisor requested and a menu.

The terminal according to preferred embodiment of the present invention may further comprise a real time clock (RTC) for providing time information.

The processor may comprise a menu display module for displaying a menu according to a request of the supervisor, a log information processing module for storing the log information transmitted from the monitor/control program in the data storing means and providing the log information to the supervisor when the supervisor requests log information; a using time control module for storing the using time information in the data storing means and providing the using time information when a user uses the computer; a program control module for storing program information of which execution is prohibited and providing the program information of which execution is prohibited when the user uses the computer; a website connection control module for storing website information of which connection is prohibited and providing the website information of which connection is prohibited when the user uses the computer; and a password certification module for determining if a password which the supervisor inputted is correct.

The using time control module may transmit a power-off message to the monitor/control program using time information of the RTC when a user uses the computer at a prohibited time.

The program control module may receive registered program information of the computer from the monitor/control program and then provides the registered program information to the supervisor.

The processor may transmit a connection confirmation message if the terminal is coupled to the computer through the data transmitting/receiving means.

The data storing means may comprise a password field for storing a password in order to determine an authorized supervisor, a program field for storing program information of which execution is prohibited, a website field for storing website information of which connection is prohibited, a log information field for storing log information which is transmitted from the monitor/control program, and a registered program field for storing registered program of the computer.

The monitor/control program may comprise a message receiving module for receiving the control information message from the monitor terminal and determining the control information; a computer operation control module for stopping the operation of the computer when the monitor terminal is not coupled to the computer and the user uses the computer at a prohibited time; a program operation control module for prohibiting execution of a program when a user tries to execute a prohibited program; a website connection control module for detecting a website that a user tries to connect with and prohibiting connection to the website if connection to the website is prohibited; a log file generation module for generating a log file storing record of usage of the computer; and a message transmitting module for transmitting log information stored in the log file to the monitor terminal.

The message transmitting module may transmit the log information whenever a record of usage of the computer is written in the log file.

The message transmitting module may transmit the log information at a predetermined time interval.

The monitor/control program may further comprise a user certification module for determining if an authorized user uses the computer.

The data transmitting/receiving means may communicate with the computer through wire cable or wire network.

The data transmitting/receiving means may communicate with the computer using a wireless networking protocol, such as Bluetooth.

The terminal according to a preferred embodiment of the present invention may be a wireless communication device including a mobile terminal.

The terminal according to a preferred embodiment of the present invention may be a personal information device including a Personal Digital Assistant (PDA).

As mentioned above according to the present invention, even computer novices can control the use of the computer easily.

Further, according to the present invention, the using time of the computer, the execution of the program as well as the connection to the harmful website can be controlled, and the record of usage of the computer can be easily monitored without turning on the computer.

Moreover, the present invention can be applied not only for controlling children's computer use but also for controlling employees' computer use in a company.

Additional aspects and advantages of the invention will be set forth in part in the description which follows, and in part will be obvious from the description, or may be learned by practice of the invention. The aspects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate several embodiments of the invention and together with the description, serve to explain the principles of the invention.

### BRIEF DESCRIPTION OF THE DRAWINGS

FIG. 1 illustrates a system where a monitor terminal for controlling the use of a computer is used according to a preferred embodiment of the present invention.

FIG. 2 illustrates a system where the monitor terminal is used according to another embodiment of the present invention.

FIG. 3 illustrates a block diagram of the monitor terminal according to a preferred embodiment of the present invention.

FIG. 4 illustrates a block diagram of a charging device according to a preferred embodiment of the present invention.

FIG. 5 illustrates a block diagram of the processor according to a preferred embodiment of the present invention.

FIG. 6 illustrates a field constitution of a data storage part according to a preferred embodiment of the present invention.

FIG. 7 illustrates a module of a monitor/control program installed in the computer according to a preferred embodiment of the present invention.

FIG. 8 illustrates a flow chart showing a process that permits control of the use of the computer to be performed according to a preferred embodiment of the present invention.

FIG. 9 illustrates a flow chart showing a process in which using time information is inputted into the monitor terminal according to a preferred embodiment of the present invention.

FIG. 10 illustrates a flow chart that permits program control information to be inputted into the monitor terminal according to a preferred embodiment of the present invention.

FIG. 11 illustrates a flow chart in which website control information is inputted into the monitor terminal according to a preferred embodiment of the present invention.

FIG. 12 illustrates a flow chart showing a process that allows the user to use the computer when the computer is turned on according to a preferred embodiment of the present invention.

FIG. 13 illustrates a flow chart showing a process whereby execution of a program is monitored according to a preferred embodiment of the present invention.

FIG. 14 illustrates a flow chart showing a process whereby a website connection is monitored according to a preferred embodiment of the present invention.

FIG. 15 illustrates an external appearance of the monitor terminal according to a preferred embodiment of the present invention.

FIG. 16 illustrates an arrangement of a keypad according to a preferred embodiment of the present invention.

FIG. 17 illustrates an example of an initial menu displayed by a menu display module displays when the monitor terminal is turned on.

FIG. 18 illustrates an example of a screen display that provides a log information about a record of usage of the computer.

FIGS. 19A, 19B and 19C illustrate an example of a screen display for designating using time.

FIG. 20 illustrates an example of a screen display which allows a supervisor to select a program by which execution of the program is prohibited.

FIG. 21a and FIG. 21b illustrate an example of a screen display for designating website connection information.

### DESCRIPTION OF THE EMBODIMENTS

Reference will now be made in detail to the present embodiments of the invention, examples of which are illustrated in the accompanying drawings. Wherever possible, the same reference numbers will be used throughout the drawings to refer to the same or like parts.

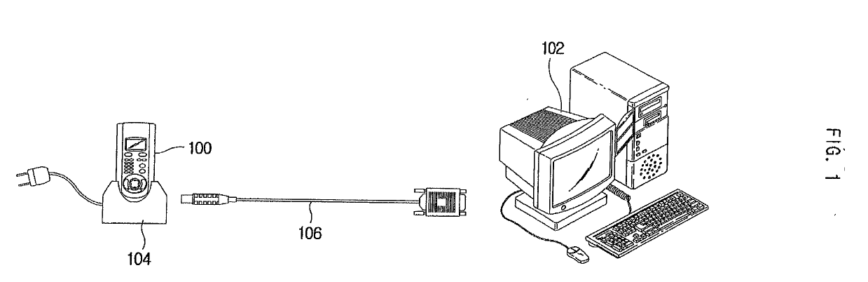

FIG. 1 illustrates a system 10 whereby a monitor terminal for controlling the use of computer is used according to a preferred embodiment of the present invention. System 10 includes a computer 102, a monitor terminal 100 for controlling the user of the computer, and charging equipment 104.

Monitor terminal 100 may store control information including computer using time, an executable program list, and a connectable website list through web-browser.

Further, monitor terminal 100 may store log information about record of usage of computer 102. If a supervisor inputs log request information using the keypad of monitor terminal 100, the supervisor can monitor the record of usage of the computer. As used herein, a supervisor could be one or more persons who administer, maintain, and/or control the usage of computer 102.

The log information includes computer using time, executed program, and website information indicating where a computer user connected.

Computer 102 does not operate if monitor terminal 100 is not coupled thereto. Coupling may be accomplished physically or in a wireless manner as known to those skilled in the art.

According to a preferred embodiment of the present invention, monitor terminal 100 may be implemented in the form of a portable device such as a mobile phone. As such, monitor terminal 100 could be considered a mobile terminal. Furthermore, monitor terminal 100 may comprise an LCD display, a keypad, and a communication connector.

Conventionally, in order to control the use of a computer, the supervisor had to execute and interact with an application program installed in the computer. However, according to the present invention, information for controlling the use of computer 102 can be inputted using monitor terminal 100, which may take the familiar form of a mobile phone. As such, input of control information is easier compared with the conventional method, and individuals who are computer novices can easily input control information and monitor the record of usage of the computer.

Monitor terminal 100 need not be an independent device dedicated to controlling the use of computer, since devices which have other primary functions, such as, for example, a mobile phone or Personal Digital Assistant (PDA), may also function as monitor terminal 100.

A monitor/control program may be installed in computer 102 for communication with monitor terminal 100. The monitor/control program may be installed in computer 102 using a floppy disk, CD ROM, Internet download, or using other methods known to those skilled in the art.

The monitor/control program cooperates with monitor terminal 100 and operates computer 102 only when monitor terminal 100 is coupled with computer 102. Further the monitor/control program may function as the driver of monitor terminal 100. In this situation, a security card which the supervisor would carry on his person, may act as a key, to allow access to monitor terminal 100 and/or monitor control program may be further included as a peripheral of the computer, such as mouse, in order to prohibit the computer user from deleting the monitor/control program.

The using time, executable programs, and connectable website information are all transmitted to computer 102 by monitor terminal 100 for controlling the use of computer 102; thus the monitor/control program controls the use of computer according to the transmitted control information.

Further, the monitor/control program creates the record of usage information of computer 102 and provides the information to monitor terminal 100.

As shown in FIG. 1, according to a preferred embodiment of the present invention, monitor terminal 100 may communicate with computer 102 through wire cable 106. Wire cable 106 may be coupled to an RS-232 serial port (such as a COM1 or COM2) or a Universal Serial Bus port (such as a USB1 or USB2) of computer 102. It should be appreciated that wire cable 106 may also be coupled to a parallel port computer 102, or to any other computer port known to those skilled in the art. When wire cable 106 is used, interface connectors such as a D-SUB type for RS232 or a USB type may be used as a connector for monitor terminal 102. Similarly, connectors for computer 102 may include a D-SUB type for RS232 or USB type connectors. Alternatively, other connectors as known to those skilled in the art may be used in conjunction with wire cable 106, monitor terminal 100, and computer 102.

According to another embodiment of the present invention, computer 102 and monitor terminal 100 may communicate by wireless communication. For example, monitor terminal 100 and computer 102 may include a bluetooth chip and communicate using a bluetooth wireless network. Alternatively, other known wireless networking protocols, such as, for example, 801.11b, may be used with this embodiment of the invention.

According to another embodiment of the present invention, monitor terminal 100 and computer 102 may communicate using a network, including the Internet, if the supervisor would like to control the use of computer remotely. In this situation, monitor terminal 100 should include the means for implementing a network protocol. In the situation were the network is the Internet, monitor terminal 100 would include the means for transmitting and receiving TCP/IP packets.

A charging device 104 performs a charging function in order to provide a source voltage to monitor terminal 100. Charging device 104 also physically supports monitor terminal 100 for convenience. As shown in FIG. 1, wire cable 106 may be coupled to the charging device 104. However, it would be obvious to those skilled in the art that wire cable 106 can be coupled directly to monitor terminal 100. Furthermore, the source voltage could be supplied to monitor terminal 100 through wire cable 106.

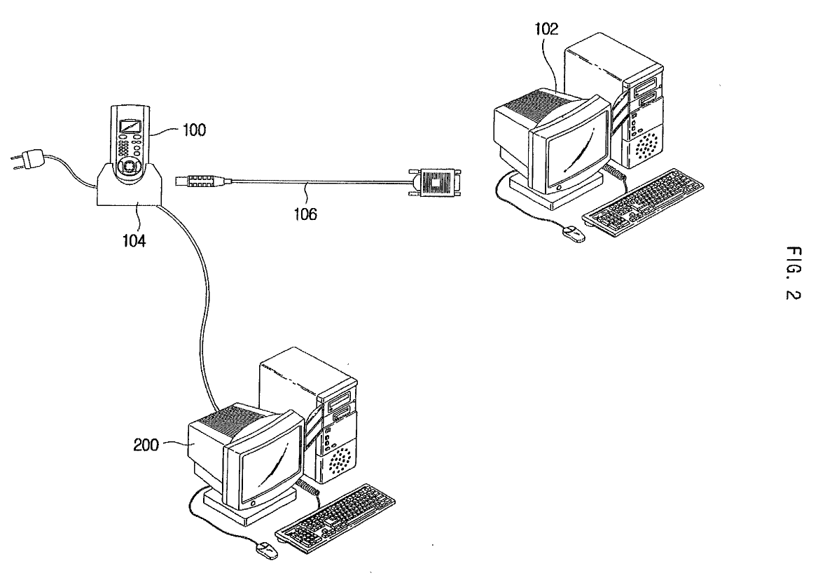

FIG. 2 illustrates a system whereby monitor terminal 100 is used according to another embodiment of the present invention.

As shown in FIG. 2, the system comprises monitor terminal 100, computer 102, charging device 104, wire cable 106, and a supervisor terminal 200. Other than supervisor terminal 200, the system of FIG. 2 is the same as the embodiment shown in FIG. 1.

In FIG. 2, monitor terminal 100 and supervisor terminal 200 are coupled so that communication is possible, and monitor terminal 100 transmits the record of usage of the computer received from the monitor/control program to supervisor terminal 200.

In the system of FIG. 1, the supervisor can monitor the record of usage of computer 102 after the user finishes using it. Therefore, the supervisor can't monitor which program the user executes and which website the user connects with in real time.

In the system of FIG. 2, the supervisor can monitor the record of usage of computer 102 in real time while performing other tasks.

Further, the supervisor can change the control information inputted in monitor terminal 100 using supervisor terminal 200. In this situation, an application program should be installed in the supervisor terminal 200 for control of monitor terminal 100.

For example, if the user connected to the website “yahoo.co.kr,” the site connection information is transmitted to monitor terminal 100 by the monitor/control program, and the information that the user has connected to the website “yahoo.co.kr” is transmitted to supervisor terminal 200 from monitor terminal 100.

Supervisor terminal 200 may be a Personal Computer (PC), a PDA, a mobile phone, and/or a dedicated hardware device.

Supervisor terminal 200 and monitor terminal 100 can communicate via a dedicated wire, a wire network, and/or wireless network. Regarding wireless communication, monitor terminal 100 and supervisor terminal 200 may communicate using bluetooth or any other wireless network known to those skilled in the art.

Regarding wire communication, monitor terminal 100 and supervisor terminal 200 may be coupled through general cables, such as serial (for example, RS-232 or USB) or parallel, or the wire network such as the Internet. If monitor terminal 100 is coupled to supervisor terminal 200 via the Internet, the supervisor can remotely monitor the record of usage of computer 102 in real time.

Besides the above-mentioned communication methods, other various communication methods can be employed and would be included in the spirit of the present invention.

In FIG. 2, monitor terminal 100 transmits the record of usage of computer 102 to supervisor terminal 200. Alternatively, computer 102 may provide the record of usage directly to supervisor terminal 200.

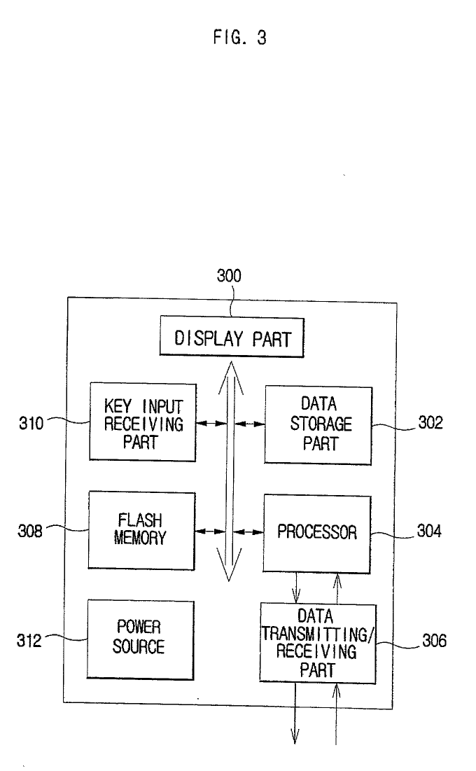

FIG. 3 illustrates a block diagram of monitor terminal 100 according to a preferred embodiment of the present invention. As shown in FIG. 3, monitor terminal 100 comprises a display part 300, a data storage part 302, a processor 304, a data transmitting/receiving part 306, a flash memory 308, a key input receiving part 310, and a power source 312.

In FIG. 3 display part 300 displays a menu needed in handling monitor terminal 100 and the record of usage information of computer 102. Display part 300 may be implemented using display technology known to those skilled in the art, such as, for example, a Liquid Crystal Display (LCD), like a typical mobile phone, and/or, a Light Emitting Diode (LED) display. Different types of displays may be used separately or in conjunction with one another.

Data storage part 302 stores control information that the supervisor inputted and log record information transmitted from computer 102. Data storage part 302 may be implemented using RAM, ROM, flash memory or other memory means. Additionally, data storage part 302 may include a hard disk or other optical storage devices. The detailed data field contained in data storage part 302 will be explained further below.

The flash memory 308 stores an operations program facilitating the operation of monitor terminal 100. ROM or other memory means may be used instead of flash memory 308.

Although flash memory 308 and the data storage part 302 are illustrated as separate constitutional elements in FIG. 3, one component can perform the function of flash memory 308 and data storage part 302 together.

Processor 304 receives request information of the supervisor and log information about record of usage of computer 102 and processes the received information. Processor 304 processes information according to the operation program stored in flash memory 308. Details regarding processor 304 will be explained more fully below.

Data transmitting/receiving part 306 may transmit and receive data with computer 102 and/or supervisor terminal 200. Specifically, data transmitting/receiving part 306 transmits a connection confirm message which indicates that monitor terminal 100 is coupled to computer 102, a control information message which includes control information inputted by the supervisor, and a log information message which includes use record information of computer 102 to supervisor terminal 200. Data transmitting/receiving part 306 receives a connection confirmation response message and control information request message and log information message regarding the record of usage of computer 102 from computer 102 and provides this received information to processor 304.

Key input receiving part 310 receives request information inputted by the supervisor using a keypad and provides it to processor 304.

Power source 312 provides operational power of monitor terminal 100. General batteries can be used as the power source or rechargeable batteries can be used as the power source. Otherwise, the power can be provided from a home power source through an adaptor.

While FIG. 3 shows key input receiving part 310, data storage part 302, processor 304, and data transmitting/receiving part 306 as separate components, one of ordinary skill in the art should appreciate that these components could be integrated together and implemented on a single chip.

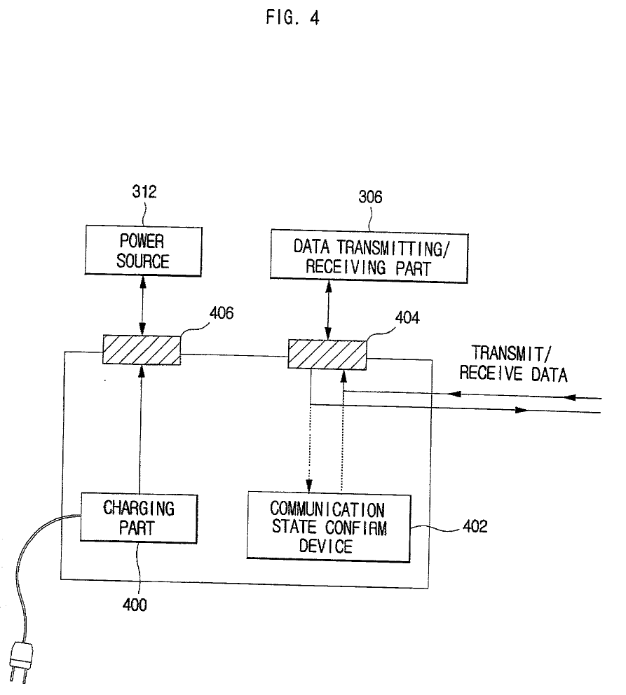

FIG. 4 illustrates a block diagram of the charging device according to a preferred embodiment of the present invention.

As shown in FIG. 4, the charging device according to a preferred embodiment of the present invention comprises a charging part 400, a communication state confirmation device 402, and connection ports 404 and 406.

Charging part 400 can be coupled to power source 312 of monitor terminal 100 through connection port 406. Charging part 400 can provide power to charge a battery that may be contained in monitor terminal 100.

Communication state confirmation device 402 determines if the data is transmitted and received; the data transmitted and received through the connection port 404 is provided to the data transmitting/receiving part 306 of monitor terminal 100.

The charging device 402 shown in FIG. 4 is an additional constitutional element of the present invention. Therefore, if the charging device is not included, the spirit and the scope of the present invention is not affected.

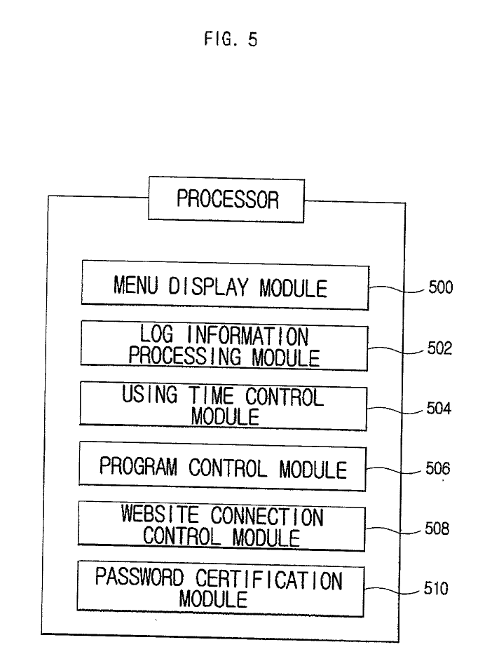

FIG. 5 illustrates a block diagram of processor 304 according to a preferred embodiment of the present invention.

As shown in FIG. 5, processor 304 according to a preferred embodiment of the present invention comprises a menu display module 500, a log information processing module, a using time control module 504, a program control module 506, a website connection control module 508, and a password certification module 510.

In FIG. 5, menu display module 500 provides a menu corresponding to the information which the supervisor had requested using the keypad of monitor terminal 100. If the supervisor inputs request information which requests a particular function, key input receiving part 310 provides the request information to processor 304, and menu display module 500 of processor 304 displays the corresponding menu after analyzing the information provided from key input receiving part 310.

For example, if the supervisor requested designation of the using time by pressing a key corresponding to the using time designation, key input receiving part 310 receives the request information and provides it to processor 304, and then menu display module 500 of processor 304 displays a menu for designation of the using time in display part 300.

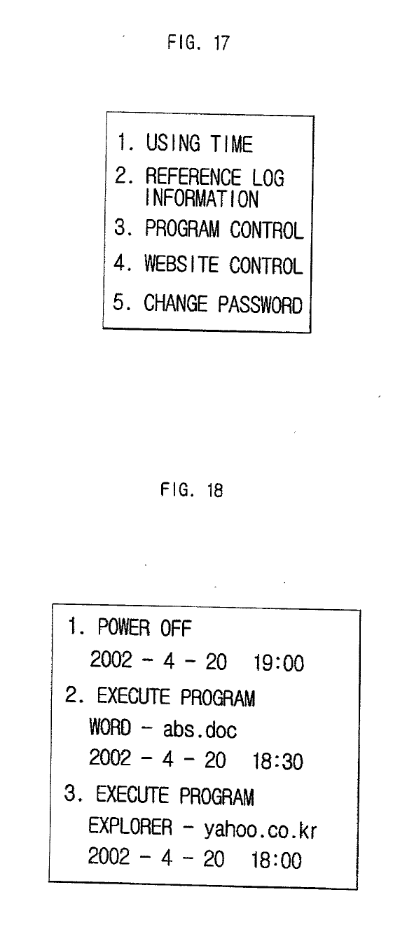

FIG. 17 illustrates an example of an initial menu which menu display module 500 displays when monitor terminal 100 is turned on.

As shown in FIG. 17, when monitor terminal 100 is turned on, menu display module 500 may display the using time designation menu, program designation menu for designating a program of which the execution is prohibited, log information menu for monitoring the log information, website designation menu for designating a website of which the connection is prohibited, and password change menu. The supervisor selects the necessary menu among the displayed menu in FIG. 17, and menu display module 500 displays a screen corresponding to the menu that the supervisor selected.

Referring again to FIG. 5, using time control module 504 controls computer 102 using time of the user in various ways. The supervisor can designate using time so that computer 102 operates for a designated time after the power of computer 102 is turned on. For example, if the supervisor designated using time as one hour, using time control module 504 controls the power source of computer 102 to operate for one hour regardless of a using time zone. As used herein, the using time zone is a time interval wherein usage of computer 102 is allowed by the supervisor.

Further, the supervisor can designate using time zone by day. For example, the supervisor designates using time zone as 7:00 PM to 9:00 PM by day. If the using time zone is designated by day, using time control module 504 controls the operation of the computer so that the computer operates only for the designated using time zone.

Further, the supervisor can designate the using time zone by week or by month. For example, the supervisor prohibits using the computer on weekdays but allows use on weekends.

According to a preferred embodiment of the present invention, using time control module 504 itself can transmit the using time control message to computer 102. That is, if the user operates computer 102 in a prohibited time, using time control module 504 transmits a message which commands computer 102 to stop operation. In this case, monitorterminal 100 may include a real time clock (RTC) in order to securely recognize present time information.

According to another embodiment of the present invention, using time control module 504 provides time information that the supervisor designated to the monitor/control program, and the monitor/control program controls the operation of the computer according to the received time information.

Preferably using time control module 504 itself controls the operation of computer 102 through the RTC because the user may possibly change the time maintained on computer 102.

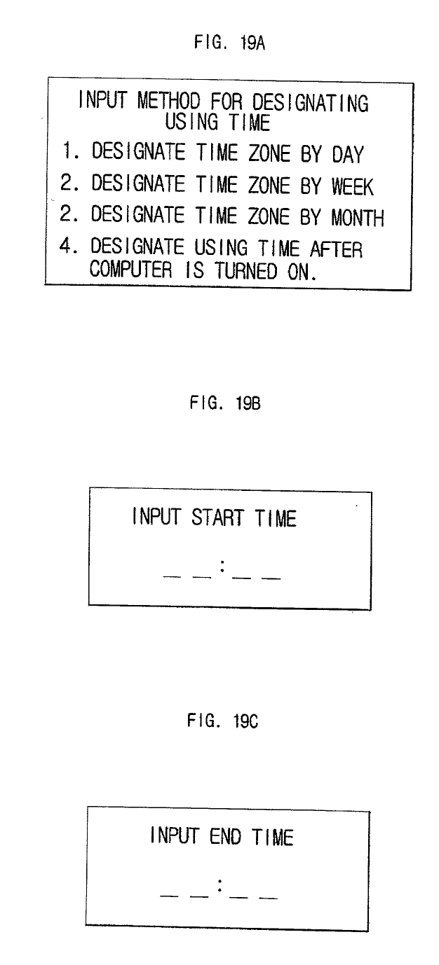

FIGS. 19a, 19b and 19c illustrate an example of the screen display for designating using time.

FIG. 19a illustrates an example of a menu when the supervisor selects time designation in the initial menu or in the keypad.

As shown in FIG. 19a, monitor terminal 100 provides a menu for designation of the using time zone by the day, a menu for designation of the using time zone by the week, a menu for designation of the using time zone by the month, and a menu for designation of using time after the computer is on regardless of the using time zone.

FIG. 19b and FIG. 19c illustrate an example of a screen display when the supervisor selected a menu for designation of the using time zone by the day. As shown in FIG. 19b and FIG. 19c, when the supervisor selected the menu for designation of the using time zone by the day, monitor terminal 100 provides a screen for inputting start time and end time of computer 102, and the supervisor can input time using the keypad of monitor terminal 100.

Program control module 506 provides registered program information of computer 102 to the supervisor and provides prohibited program information to the monitor/control program.

The monitor/control program provides registered program list of computer 102 to the monitor terminal 102 when the power of computer 102 is turned on. Further, if new programs are registered, the monitor/control program detects the registration of the new program and provides the corresponding information to monitor terminal 100.

Received information is stored in data storage part 302, and program control module 506 provides stored information to the supervisor. Preferably the program name as well as the execution file of the program is provided together since the supervisor may not know the program name when only the execution file information is provided.

Program execution control module 506 receives information that the supervisor inputted and when the user turns on computer 102; program control module 506 provides information about a program of which the execution is prohibited.

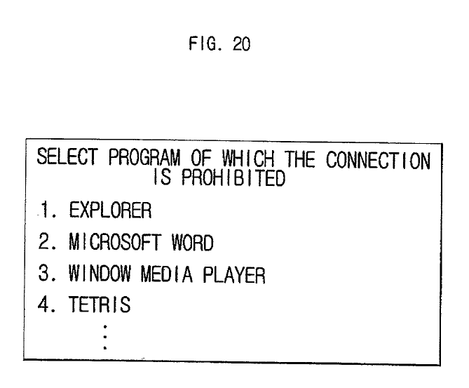

FIG. 20 illustrates an example of a screen display wherein the supervisor selects a program for which the execution on computer 102 is prohibited.

As shown in FIG. 20, the registered program list of computer 102 is displayed in monitor terminal 100, and the supervisor selects a program for which the execution on computer 102 is prohibited among those displayed program list.

Again referring to FIG. 5, website connection control module 508 provides website connection information to the supervisor; this information includes the websites that the user accessed. Website connection control module 508 can also provide information regarding websites for which access is prohibited to the monitor/control program.

As mentioned above, information regarding a website for which the user has connected with is provided to monitor terminal 100, and website connection control module 508 provides this received information when the supervisor requests it. The supervisor selects a website for which the connection is prohibited among the provided website information, and then website connection control module 508 receives the selection information and generates a control signal in order to store the selection information in data storage part 302.

The supervisor cannot only select a website of which the connection is prohibited among the connected websites list, but also input a website Universal Resource Locator (URL) for which the connection is prohibited. Website connection control module 508 receives website information which the supervisor inputs and generates a control signal in order to store the inputted information in data storage part 302.

When the user turns on computer 102, website connection control module 508 provides information of the website of which the connection is prohibited to the monitor/control program.

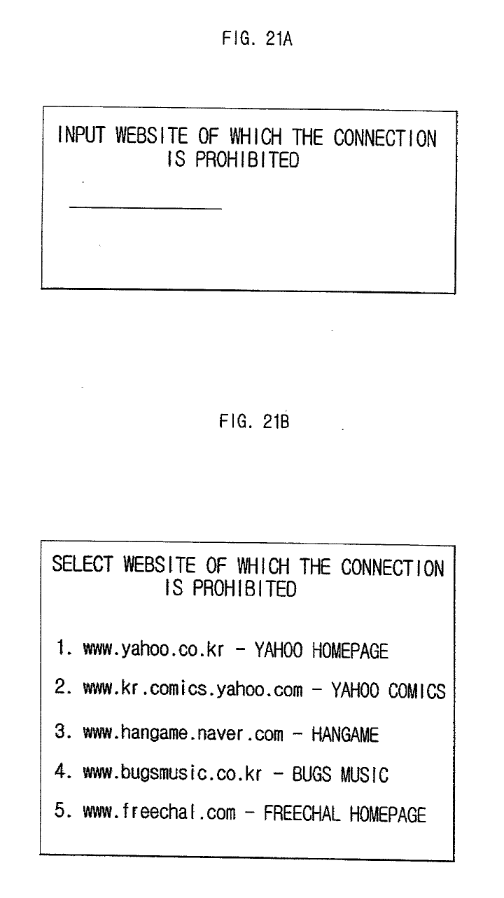

FIG. 21a and FIG. 21b illustrate an example of a screen display for designating website connection information.

FIG. 21a illustrates an example of displaying a menu that the supervisor inputs website URL for which the connection is prohibited. FIG. 21b illustrates an example of displaying a menu of websites for which the user has connected to in the past, from which the supervisor may select one or more websites for which the user will be prohibited from connecting to in the future. As shown in FIG. 21b, a brief explanation of the website as well as the website URL are preferably displayed together so that the supervisor can determine the characteristic of the website to which the user has connected.

Referring again to FIG. 5, log information processing module 402 receives a log information message from the monitor/control program and stores the log information included in the message in data storage part 302, and provides the log information according to the request of the supervisor.

The monitor/control program transmits the log information message at a predetermined time interval or when an event occurs. Log information processing module 502 determines that a received message is the log information message through the identifier of the message and derives log data from the message and stores the log data in data storage part 302

If supervisor terminal 200 is coupled to monitor terminal 100 through wire or wireless network, log information processing module 502 may transmit the log information to supervisor terminal 200 whenever monitor terminal 100 receives a log information message from the monitor/control program.

FIG. 18 illustrates an example of screen display that provides the log information about the record of usage of the computer.

As shown in FIG. 18, monitor terminal 100 provides not only the information of the executed program but also the performance information of the program. In FIG. 18, if the user executed a word program, log information processing module 502 provides not only the name of the executed program but also the file name edited by the word program as the performance information of the program.

Password certification module 510 certifies the password in order to determine if the authorized supervisor may use monitor terminal 100. Password certification module 510 prohibits the use of monitor terminal 100 if the input password is not correct.

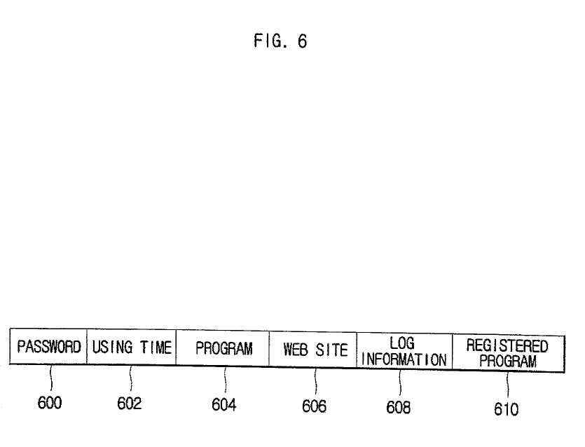

FIG. 6 illustrates a field constitution of the data stored in data storage part 302 according to a preferred embodiment of the present invention.

As shown in FIG. 6, the information contained in data storage part 302 according to a preferred embodiment of the present invention includes password field 600, using time field 602, program field 604, website field 606, log information field 608, and registered program field 610.

In password field 600, a password that the supervisor had designated is stored. When the supervisor inputs a password in order to use monitor terminal 100, password certification module 510 references password field 600, and if the inputted password is not same as the stored password, password certification module 510 prohibits the use of monitor terminal 100.

In using time field 602, the using time information that the supervisor designated is stored. Using time control module 504 stores the using time information in the using time field 602 and provides using time information to the monitor/control program by referencing the using time field 602 when the user turns on computer 102.

In program field 604 the information regarding a program, for which the execution on computer 102 is prohibited, is stored.

In website field 606 the information of the website for which the connection is prohibited is stored. Website connection control module 508 provides the information of the website for which the connection is prohibited by referencing website field 606, and website connection control module 508 stores the information of the website inputted by the supervisor in website field 606.

In log information field 608 the log information about the record of usage of the computer, transmitted from the monitor/control program, is stored. If the supervisor requests log information using monitor terminal 100, log information processing module 502 displays data stored in log information field 608.

The log information field 608 may include using time field, executed program field, and program performance field. In the using time field, the duration of time that the user used a program is stored. In the executed program field, the program information that the user executed is stored. In program performance field, the particulars that the user performed with corresponding program are stored. For example, if the user executed a word program, in the program performance field stores the file name that the user edited with the word program. If the user executed a web-browser, in the program performance field stores the information of website which the user connected.

In registered program field 610, a registered program list of computer 102 is stored. If the supervisor requests designation of a program of which the execution is prohibited, program control module 506 provides a registered program list stored in registered program field 610 so that the may supervisor select the program for which execution is prohibited. As mentioned above, in registered program field 610, the program name, as well as the program executable file, are stored

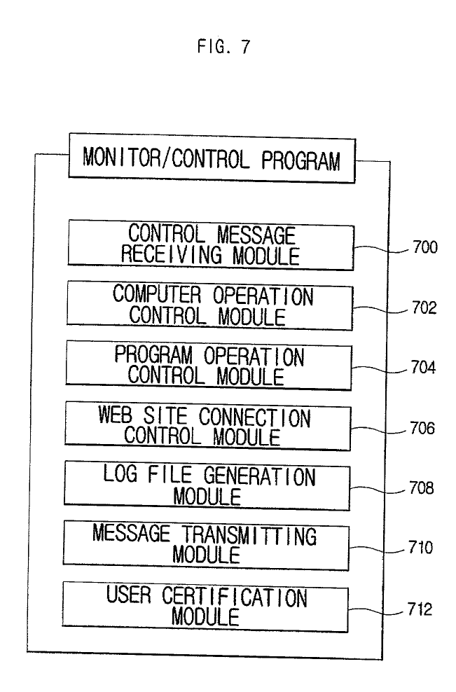

FIG. 7 illustrates a module of the monitor/control program installed in computer 102 according to a preferred embodiment of the present invention.

As shown in FIG. 7, the monitor/control program according a preferred embodiment of the present invention comprises control message receiving module 700, computer operation control module 702, program operation control module 704, website connection control module 706, log file generation module 708, message transmitting module 710, and user certification module 712.

The control message receiving module 700 receives a control information message and recognizes control information which the supervisor designated.

If control message receiving module 700 receives the control information message, control message receiving module 700 stores the control information in RAM, other memory, and/or a hard disk of computer 102 in order to control the use of computer 102.

Computer operation control module 702 stops the operation of computer 102 if the user turns on the computer during a prohibited time.

As mentioned above according to an embodiment of the present invention, monitor terminal 100 determines if the user turns on the computer within an allowed time. In this situation, monitor terminal 100 transmits information that the user turned on computer within a prohibited time to the monitor/control program and computer operation control module 702 receives the information and stops the operation of computer 102.

According to another embodiment of the present invention, computer operation control module 702 determines if the user turns on the computer within an allowed time. Computer operation control module 702 determines if the user turns on the computer within an allowed time by using a clock within computer 102, an operating system clock (e.g., a Windows clock), and/or an external clock signal which may, for example, be derived from a signal originating from a network.

Computer operation control module 702 also stops the operation of the computer if monitor terminal 100 is not coupled to computer 102.

According to a preferred embodiment of the present invention, computer operation control module 702 provides a control signal that commands the power off to the Operating System (O/S) power control module included in the operation system, and the O/S power control module receives the control signal of computer operation control module 702 and turns off the power of computer 102.

Program operation control module 704 detects a user's execution of the program and stops the execution of the program if the user executes a prohibited program.

Program operation control module 704 requests the operation system of computer 102 to transmit a user's mouse click information or execution information. The operating system provides the user's mouse click information or execution information to program operation control module 704 according to the request of program operation control module 704, and the program operation control module 704 determines if the user has executed a prohibited program through the provided information from the operating system.

Website connection control module 706 detects the website that the user tries to connect to, and if the user has connected to the prohibited website, website connection control module 706 stops the connection to the website.

Website connection control module 706 requests the operation system or the web-browser to provide the website information whenever the user tries to connect to a website, and website connection control module 706 determines if the user connects to the prohibited website through the provided information.

Log file generation module 708 generates a log file that includes record of usage information of computer. Log file generation module 708 receives program information that the user has executed and performance information of the program from program operation control module 704, and stores the information as a file. When the user executes a web-browser, log file generation module 708 stores website information which the user connected by referencing a history file of the web-browser or through the communication with website connection control module 706. When log file generation module 708 stores website information, preferably the log file generation module 708 stores not only the URL of the website but also the tag message of the website displayed on the upper part of the web-browser. This assists the supervisor in determining if the connected website is harmful when only the URL information is provided.

Message transmitting module 710 transmits a message to monitor terminal 100. Specifically, the message transmitting module 710 transmits a response message about a connection confirmation message of monitor terminal 100, control information request message, and log information message to monitor terminal 100.

User certification module 712 certifies the password of a user in order to determine if the user is authorized to use computer 102. User certification module 712 prohibits the use of computer 102 if the input password supplied by the user is not correct.

According to another embodiment of the present invention, the monitor/control program installed in the computer may be implemented as a peripheral device in the form of a card inserted in the board slot. For example, the monitor control program is implemented as a card in order to authorize a user, prevention of lock release, prevention of deleting the monitor/control program, and automatic recovery of the deleted monitor/control program. The above-mentioned function can be achieved by an outer application device, and it would be apparent to those skilled in the art that a change in the form of the monitor/control program does not affect the scope of the invention.

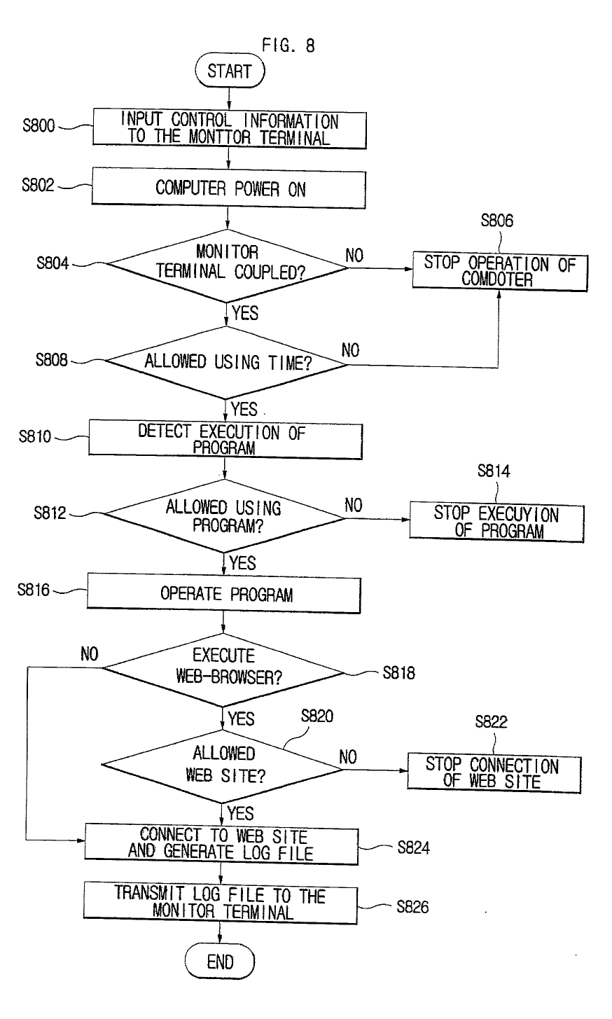

FIG. 8 illustrates a flowchart showing the process that controls the use of computer 102. As shown in FIG. 8, the supervisor inputs the control information for controlling the use of the computer by using monitor terminal 100 (Step S800). The supervisor may input the control information using a keypad of monitor terminal 100 (which may be a mobile terminal) or may input the control information using computer 102 or the supervisor terminal 200.

If the user turns on the power of computer 102 (Step S802), the monitor/control program determines if monitor terminal 100 is coupled to computer 102 (Step S804)

If monitor terminal 100 is not coupled to computer 102, the monitor/control program stops the operation of the computer so that user can't use computer 102 (Step S806).

If monitor terminal 100 is coupled to computer 102, the monitor/control program determines if the user had turned on computer 102 within an allowed using time (Step S808). If the user turned on computer 102 within a prohibited time, the monitor/control program stops the operation of computer 102 (Step S806).

If monitor terminal 100 is coupled and the user turns on computer 102 within an allowed using time, the monitor/control program allows the use of computer 102 and determines if the user executes a program (Step S810).

If the monitor/control program detects the execution of the program, the monitor/control program determines if the executed program is a prohibited program (Step S812).

If the executed program is a prohibited program, the monitor/control program stops the execution of the program (Step S814).

If the executed program is not a prohibited program, the executed program operates (Step S816).

Further, the monitor/control program determines if the executed program is a web-browser (Step S818).

If the executed program is web-browser, the monitor/control program detects the website which the user tries to connect and determines if this website is a prohibited website (Step S820).

If the website that user tries to connect is a prohibited website, the monitor/control program stops the connection process (Step S822).

If the user executed another program besides the web-browser or the website that the user tries to connect is not a prohibited website, the monitor/control program allows the use of the program and generates a log file of the record of usage (Step S824).

The monitor/control program transmits the generated log file to monitor terminal 100, and then monitor terminal 100 stores the received log file in log information field 608 of data storage part 302 (Step S826).

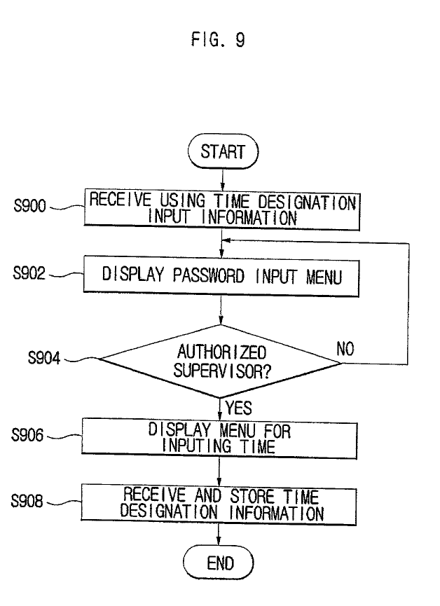

FIG. 9 illustrates a flow chart showing the process that the using time information is inputted into the monitor terminal according to a preferred embodiment of the present invention.

As shown in FIG. 9, monitor terminal 100 receives request information for designating the using time from the supervisor (Step S900). The supervisor inputs the request information using a keypad of monitor terminal 100, and the key input receiving part 310 of monitor terminal 100 transmits the inputted information to processor 304.

A menu for inputting a password is displayed in display part 300 in order for processor 304 to determine if the authorized supervisor is using monitor terminal 100 (Step S902).

The supervisor inputs the password into the displayed menu, and monitor terminal 100 receives the inputted password and determines if the correct password has been inputted (Step S904). In order to determine if the correct password has been inputted, password certification module 510 compares the inputted password with the password stored in password field 600.

If the inputted password is the not the same as the stored password, monitor terminal 100 displays certification fail message and displays password input menu again, which prohibits the use of monitor terminal 100.

If the inputted password is the same as the stored password, the menu for inputting time is displayed (Step S906).

As mentioned above, the using time zone may be designated by the day, week, and month; or otherwise after the computer is turned on the using time is designated regardless of the time zone.

Using time control module 504 receives the inputted information from the supervisor and stores the information in using time field 602 of data storage part 302 (Step S908).

FIG. 10 illustrates a flow chart that program control information is inputted into monitor terminal 100.

As shown in FIG. 10, monitor terminal 100 receives request information for inputting program control information (Step S1000). The supervisor inputs the request information for inputting program control information by using the keypad of monitor terminal 100, and the key input receiving part 310 detects the request information of the supervisor and transmits the request information to processor 304.

Processor 304 displays a password input menu, in order to determine if the authorized supervisor is using the monitor terminal (Step S1002).

The supervisor inputs a password in the displayed menu, and then monitor terminal 100 determines if the inputted password is correct (Step S1004). Password certification module 510 compares the inputted password with the stored password in password field 600 in order to determine if the correct password was inputted.

If the inputted password is not the same as the stored password, monitor terminal 100 displays certification fail message and displays the password input menu again, which prohibits the use of monitor terminal 100.

If the inputted password is the same as the stored password, the program control module displays a registered program list stored in the registered program list (Step S1006).

The supervisor selects a program of which the execution is prohibited, and the program control module receives the selection information of the supervisor and then stores the information in the program field of data storage part 302 (Step S1008).

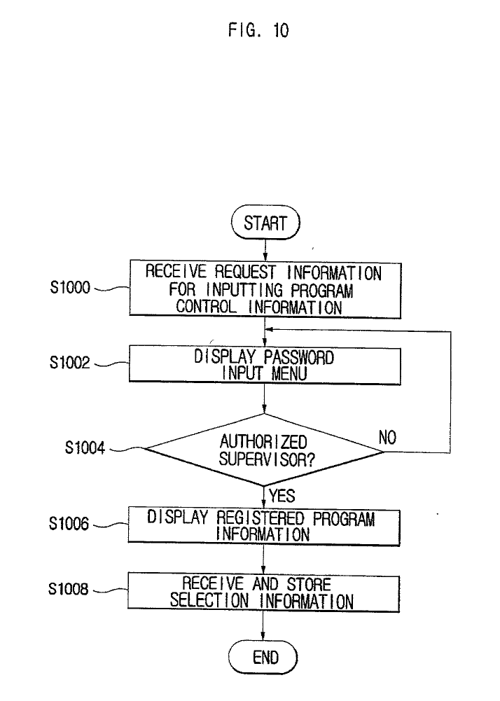

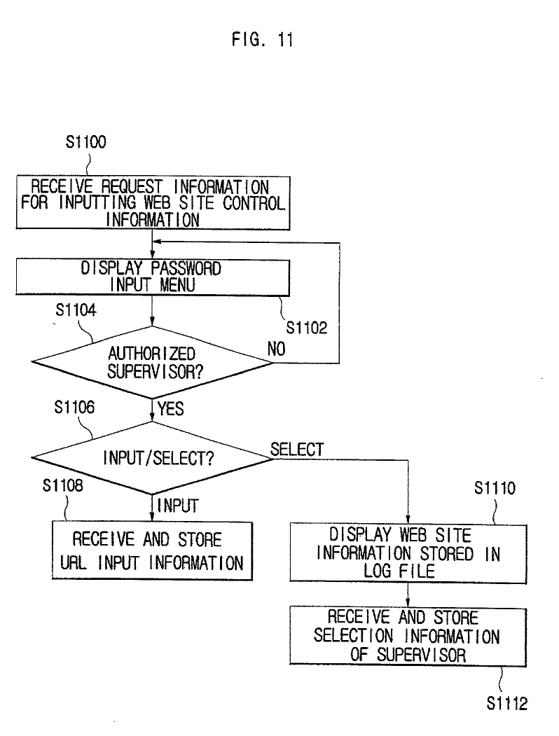

FIG. 11 illustrates a flow chart that website control information is inputted in monitor terminal 100.

As shown in FIG. 11, initially monitor terminal 100 receives request information for inputting website control information from the supervisor (Step S1100). The supervisor inputs the request information using the keypad of monitor terminal 100, and then key input receiving part 310 detects the request information and transmits the information to processor 304

Processor 304 displays a password input menu in order to determine if the authorized supervisor is using monitor terminal 100 (Step S1102).

The supervisor inputs a password in the displayed menu, and monitor terminal 100 determines if the correct password has been inputted (Step S1104). Password certification module 510 compares the inputted password with the stored password in password field 600 in order to determine if the correct password was inputted.

If the inputted password is not the same as the stored password, monitor terminal 100 displays a certification fail message and displays the password input menu again, which prohibits the use of monitor terminal 100.

If the inputted password is the same as the stored password, website connection control module 508 displays a menu for selecting the input method (Step S1106). The supervisor can input the website URL of which the connection is prohibited directly or the supervisor can select the website of which the connection is prohibited among the website list which the user connected in the past.

If the supervisor selects the method for selecting the website of which the connection is prohibited among the websites which the user previously connected, website connection control module 508 displays the website list which the user connected by referencing the log field of data storage part 302 (Step S1110).

If the supervisor selects the method for inputting website URL by himself, website control module 508 receives the inputted URL information and stores the information in the website field 606 of the data storage part 302 (Step S1112).

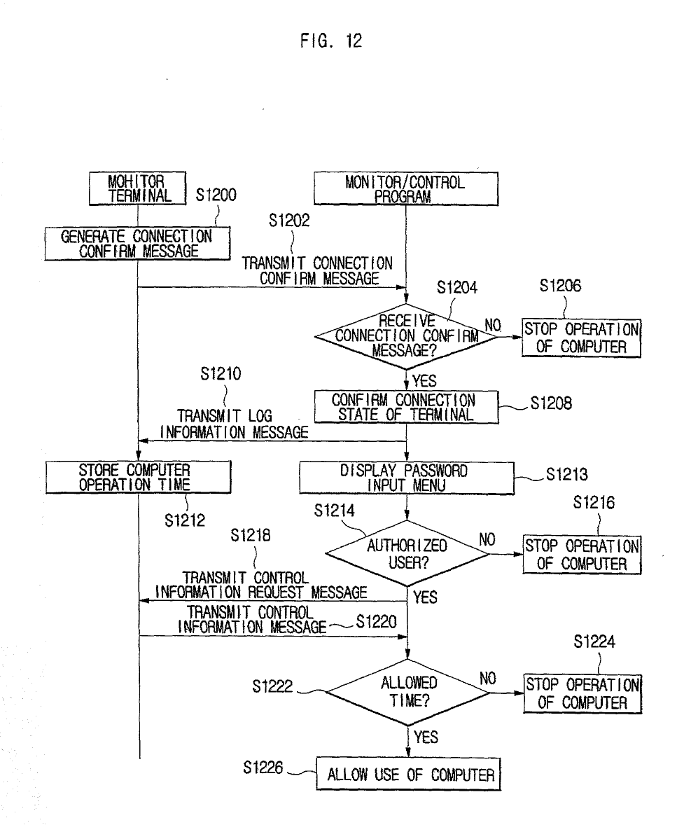

FIG. 12 illustrates a flow chart showing the process that allows the user to use computer 102 when it is turned on. As shown in FIG. 12, monitor terminal 100 generates a connection confirmation message (Step S1200) and transmits it to computer 102 continuously (Step S1202).

When the user turns on computer 102, the monitor/control program operates and the monitor/control program determines if the connection confirmation message is transmitted (Step S1204).

If the connection confirmation message is not transmitted, the monitor/control program determines that monitor terminal 100 is not coupled to computer 102 and stops the operation of the computer (Step S1206). As mentioned, computer operation control module 702 stops the operation of computer 102 by requesting the O/S power control module to turn off the power of computer 102.

If the connection confirmation message is transmitted (Step S1202), the monitor/control program determines that monitor terminal 100 is coupled to the computer (Step S1208).

If it is determined that monitor terminal 100 is coupled to computer 102, the monitor/control program transmits the log information message about the time when computer 102 is turned on (Step S1212).

The monitor/control program displays a password input menu when the user turns on computer 102 (Step S1213).

According to a preferred embodiment of the present invention, the monitor/control program distinguishes the user password from the supervisor password. For example, if the supervisor password is inputted, the monitor/control program allows the use of computer 102 without the control of monitor terminal 100. If the user password is inputted, the monitor/control program controls the use of computer according to the control information transmitted from monitor terminal 100.

If the user password being inputted is not the same as the stored password, the monitor/control program determines, using user certification module 712, that the user is not authorized and stops the operation of the computer (Step S1216).

If the correct password is inputted by the user, message transmission module 710 transmits the control information request message to monitor terminal 100 (Step S1218).

Monitor terminal 100 provides a control information message to the monitor/control program when monitor terminal 100 receives a control information request message from the monitor/control program (Step S1220).

In another embodiment, control information transmitted from monitor terminal 100 may vary depending on the identity of the user, which would be determined from the user password. For example, the list of restricted programs or websites may be changed depending on the user password provided in Step 1214.

According to a preferred embodiment of the present invention, the control information message includes the computer using time information, the program information of which the execution is prohibited, and the website information of which the connection is prohibited.

The monitor/control program receives the control information message and determines if the user is using the computer within an allowed time (Step S1222).

If the user does not use computer within an allowed time, the monitor/control program stops the operation of computer 102 (Step S1224), but if not, allows the use of computer 102 (Step S1226).

As mentioned above, according to another embodiment of the present invention, the determination if the user uses the computer within an allowed time may be performed by monitor terminal 100. In this situation monitor terminal 100 includes the RTC.

When monitor terminal 100 controls the using time of computer 102, monitor terminal 100 determines if the time when the user is using computer 102 is an allowed time. Accordingly, if the user uses computer 102 within a prohibited time, monitor terminal 100 transmits a control message to the monitor/control program that commands the operation of computer 102 to stop.

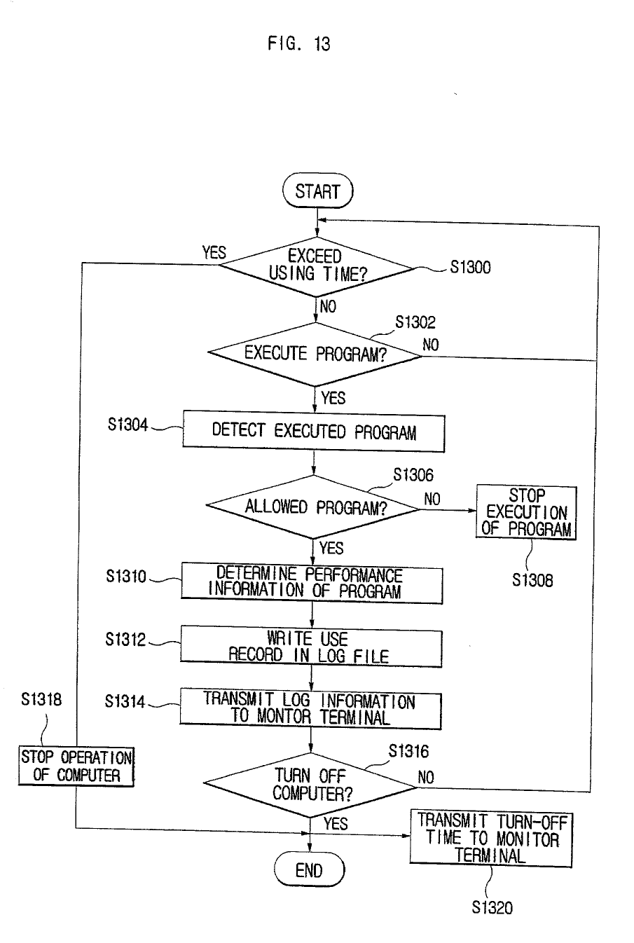

FIG. 13 illustrates a flow chart showing the process when the execution of the program is monitored.

While the user uses computer 102, continuous monitoring occurs whether the computer using time exceeds the predetermined using time (Step S1300). As mentioned above, monitor terminal 100 may monitor the using time or the monitor/control program may monitor the using time according to a control message from monitor terminal 100.

Program operation control module 704 of the monitor/control program determines if the user executes the program registered in computer 102 (Step S1302). As mentioned above, the operating system of the computer provides the user's mouse click information or the execution information to the program operation control module in order to detect the execution of the program.

If a program is executed, program operation control module 704 detects the executed program (Step S1304).

If the executed program is detected, program operation control module 704 references the program information included in the control information message and determines if the executed program is a prohibited program (Step S1306).

If the executed program is a prohibited program, program operation control module 704 stops the execution of the corresponding program (Step S1308).

If the executed program is not a prohibited program, program operation control module 704 allows the execution of the program and determines the performance information of the executed program (Step S1310).

Log file generation module 708 writes the executed program information and the performance information of the executed program in the log file (Step S1312).

Further, message transmitting module 710 transmits the log information message to monitor terminal 100 (Step S1314).

According to a preferred embodiment of the present invention, message transmitting module 710 may transmit the log information message whenever an event such as the execution of the program occurs.

According to another embodiment of the present invention, message transmission module 710 may transmit the log information message at a predetermined time interval.

As described above monitoring of the execution of the program continues until computer 102 is turned off (Step S1316). If the using time is exceeded while the user is using computer 102, the operation of computer 102 is stopped after log information is transmitted to monitor terminal 100 (Step S1320).

When the user turns off computer 102, the log file about the turn-off time of computer 102 is generated and transmitted to monitor terminal 100. Monitor terminal 100 stores the turn-off time of computer 102.

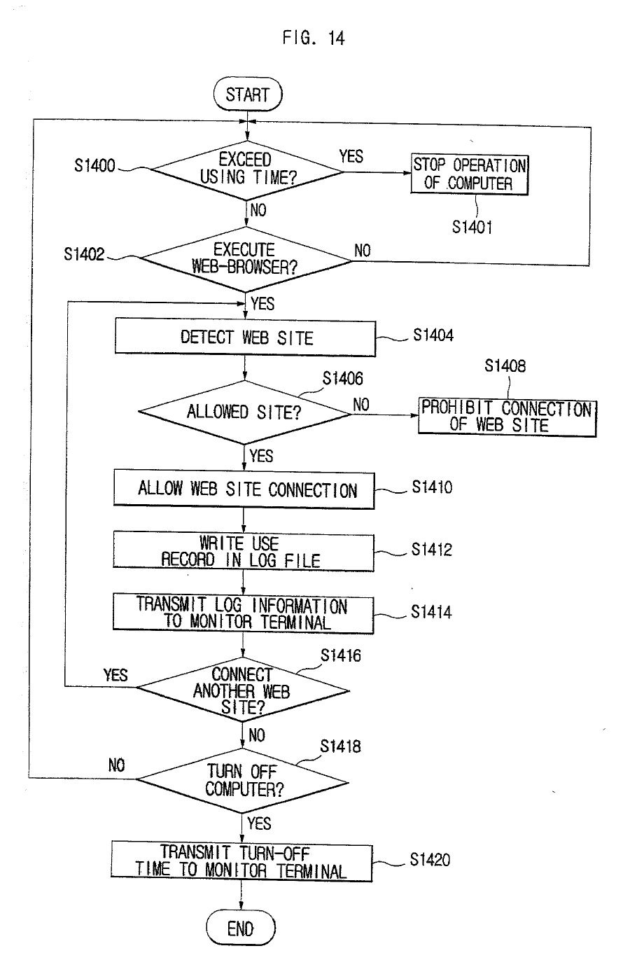

FIG. 14 illustrates a flow chart showing the process when the website connection is monitored according to a preferred embodiment of the present invention.

While the user uses computer 102, continuous monitoring occurs whether the using time exceeds the predetermined using time (Step S1300). If the using time exceeds the predetermined using time then operation of computer 102 is stopped (Step S1401).

Website connection control module 706 determines if the user executes the web-browser (Step S1402).

If the user executes the web-browser, website connection control module 706 detects the website which the user tries to connect (Step S1404). As mentioned above, website connection control module 706 detects the website which the user tries to connect by communicating with the operating system of computer 102 or the web-browser.

After detecting the website which user tries to connect, website connection control module 706 determines if the website which the user tries to connect is a prohibited website by referencing the control information included in the control information message (Step S1406).

If the website which the user tries to connect is a prohibited website, website connection control module 706 prohibits the connection of the corresponding website (Step S1408).

If the website which the user tries to connect is not a prohibited website, the website connection control module 706 allows the connection of the corresponding website (Step S1410).

Log file generation module 708 writes the connected site information in the log file (Step S1412), and message transmitting module 710 transmits the log information message to monitor terminal 100 (Step S1414).

Website connection control module 706 detects if the user tries to connect with another website (Step S1416). If the user tries to connect with another website, website connection control module 706 repeats the above mentioned process that determines if the user is trying to connect with an allowed website and generates and transmits the log file.

The monitor/control program then judges whether or not a command to turn off computer 102 had been issued (Step S1418).

If computer 102 is commanded to turned off, message transmitting module 710 of the monitor/control program transmits the turn-off time to monitor terminal 100 (Step S1420).

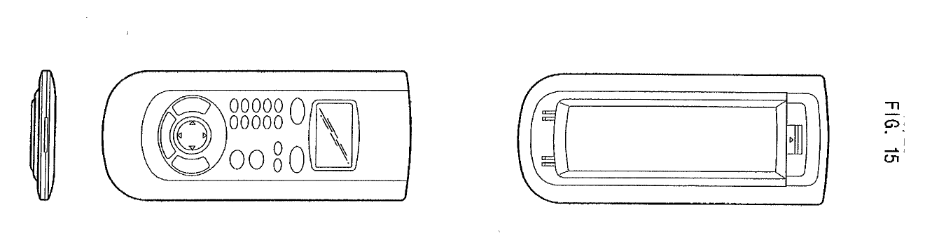

FIG. 15 illustrates, from three different perspectives, an external appearance of monitor terminal 100 according to a preferred embodiment of the present invention.

As shown in FIG. 15, monitor terminal 100 is preferably manufactured as the mobile terminal, which may be a form consistent with mobile phone. Since one aspect of the invention is directed towards use by computer novices, the appearance of monitor terminal 100 being similar to a mobile phone may be less intimidating, and therefore computer novices will find monitor terminal 100 easier to use.

FIG. 15 illustrates only one example of the external appearance of monitor terminal 100, and it would be apparent to those skilled in the art that a change of the external appearance would not affect the scope of the invention.

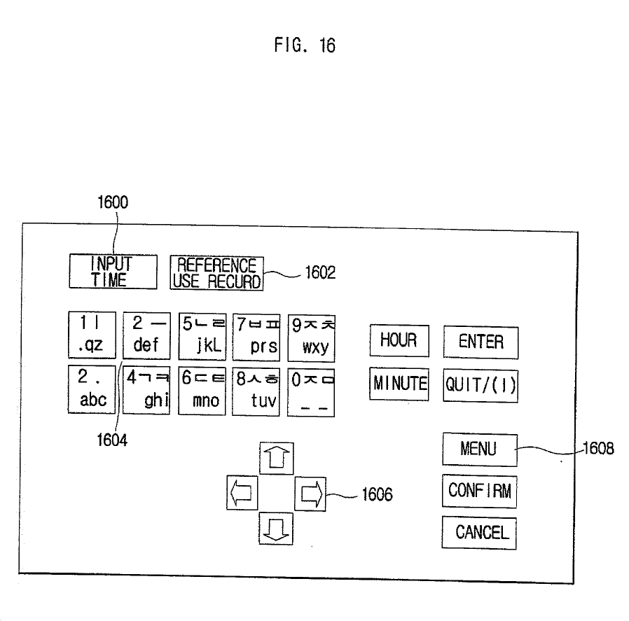

FIG. 16 illustrates a composition of the keypad according to a preferred embodiment of the present invention.

As shown in FIG. 16, the keypad according to a preferred embodiment of the present invention includes a time designation button 1600, button for referencing record of usage 1602, and buttons for inputting numbers and letters 1604. Since menus associated with the time designation and reference of the record of usage are the most frequently used, it would be convenient to the supervisor, and thus preferable, to include dedicated buttons for time designation and for referencing the record of usage.

Further, scroll buttons 1606 for easily selecting the listed menu are provided, along with a button for displaying the menu 1608.

The keypad shown in FIG. 16 is a preferred embodiment of the present invention, and it would be apparent to those skilled in the art that the change of the composition of the keypad would not affect the scope of the invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A terminal for controlling use of a computer by operating together with a monitor/control program installed in the computer comprising:
a key input receiving means for receiving control information including computer using time information, executable program information, and connectable website information which a supervisor inputs;
a data storing means for storing log information about a record of usage of the computer which is transmitted from the monitor/control program and the control information which the supervisor inputs;
a memory for storing a program for controlling operation of the terminal;
a processor for generating a control information message according to the control information which the supervisor inputs and processing a supervisor's request information and messages transmitted from the monitor/control program;
a data transmitting/receiving means for transmitting the control information message to the monitor/control program and receiving the log information about the record of usage of the computer from the monitor/control program; and
a display means for displaying information which the supervisor requested and a menu.

2. The terminal of claim 1, further comprising a real time clock (RTC) for providing time information.

3. The terminal of claim 1, wherein the processor comprises:
a menu display module for displaying the menu according to request of the supervisor;
a log information processing module for storing the log information transmitted from the monitor/control program in the data storing means and providing the log information to the supervisor when the supervisor requests log information;
a using time control module for storing the using time information in the data storing means and providing the using time information when a user uses the computer;
a program control module for storing program information of which execution is prohibited and providing the program information of which execution is prohibited when the user uses the computer;
a website connection control module for storing website information of which connection is prohibited and providing the website information of which connection is prohibited when the user uses the computer; and
a password certification module for determining if a password which the supervisor inputted is correct.

4. The terminal of claims 2 or 3, wherein the using time control module transmits a power-off message to the monitor/control program using time information of the RTC when the user uses the computer within a prohibited time.

5. The terminal of claim 3, wherein the program control module receives registered program information of the computer from the monitor/control program and provides the registered program information to the supervisor.

6. The terminal of claim 1, wherein the processor transmits a connection confirmation message if the terminal is coupled to the computer through the data transmitting/receiving means.

7. The terminal of claim 1, wherein the data storing means comprises:
a password field for storing a password in order to determine an authorized supervisor, a program field for storing program information of which execution is prohibited, a website field for storing website information of which connection is prohibited, a log information field for storing log information which is transmitted from the monitor/control program, and a registered program field for a storing registered program of the computer.

8. The terminal of claim 3, wherein the monitor/control program comprises:
a message receiving module for receiving the control information message from the terminal and determining the control information;
a computer operation control module for stopping operation of the computer when the terminal is not coupled to the computer and the user uses the computer within a prohibited time;
a program operation control module for prohibiting execution of a program when the user tries to execute a prohibited program;
a website connection control module for detecting a website which the user tries to connect and prohibiting connection to the website if connection to the website is prohibited;
a log file generation module for generating a log file storing record of usage of the computer; and
a message transmitting module for transmitting log information stored in the log file to the terminal.

9. The terminal of claim 8, wherein the message transmitting module transmits the log information whenever the record of usage of the computer is written in the log file.

10. The terminal of claim 8, wherein the message transmitting module transmits the log information within a predetermined time interval.

11. The terminal of claim 8, wherein the monitor/control program further comprises a user certification module for determining if an authorized user is using the computer.

12. The terminal of claim 1, wherein the data transmitting/receiving means communicates with the computer via one of a wire cable and wire network.

13. The terminal of claim 1, wherein the data transmitting/receiving means communicates with the computer using bluetooth.

14. The terminal of claim 1, wherein the terminal is a wireless communication device including a mobile terminal.

15. The terminal of claim 1, wherein the terminal is a personal information device including a personal digital assistant.

16. The terminal of claim 1, wherein the key input receiving means, the data storing means, the processor, and the data transmitting/receiving means are implemented as a single chip.

17. The terminal of claim 1, wherein the data storing means is one of a flash memory, a RAM, a ROM, and a hard disk.

18. The terminal of claim 8, wherein the message transmitting module transmits the log information when a particular event including turn-off of the computer occurs.

19. The terminal of claim 1, wherein the terminal is coupled to a peripheral device of the computer including a mouse.

20. The terminal of claim 1, wherein the terminal's partial function including prevention of lock release, prevention of deleting the monitor/control program, and automatic recovery of the deleted monitor/control program is achieved by a peripheral device including a computer card.

21. A terminal for controlling use of a computer by operating together with a monitor/control program installed in the computer and providing computer usage information to a supervisor terminal which is coupled to the terminal comprising:
a key input receiving means for receiving control information including computer using time information, executable program information, and connectable website information which a supervisor inputs;
a data storing means for storing log information about record of usage of the computer which is transmitted from the monitor/control program and the control information which the supervisor inputs;
a memory for storing a program for controlling operation of the terminal;
a processor for generating a control information message according to the control information which the supervisor inputs and processing the supervisor's request information and messages transmitted from the monitor/control program;
a data transmitting/receiving means for transmitting the control information message to the monitor/control program and receiving the log information about record of usage of the computer from the monitor/control program and transmitting the log information to the supervisor terminal; and
a display means for displaying information which the supervisor requested and a menu.

22. The terminal of claim 21, wherein the processor comprises:
a menu display module for displaying the menu according to request of the supervisor,
a log information processing module for storing the log information transmitted from the monitor/control program in the data storing means and providing the log information to the supervisor when the supervisor requests log information;
a using time control module for storing the using time information in the data storing means and providing the using time information when a user uses the computer;
a program control module for storing program information of which execution is prohibited and providing the program information of which execution is prohibited when the user uses the computer;
a website connection control module for storing website information of which connection is prohibited and providing the website information of which connection is prohibited when the user uses the computer; and
a password certification module for determining if a password which the supervisor inputted is correct.

23. The terminal of claim 21, wherein the data transmitting/receiving means communicates with the computer through one of a wire cable and wire network.

24. The terminal of claim 21, wherein the data transmitting/receiving means communicates with the computer using bluetooth.

25. The terminal of claim 21, wherein the key input receiving means, the data storing means, the processor, and the data transmitting/receiving means are implemented as a single chip.

26. The terminal of claim 21, wherein the data storing means is one among a flash memory, a RAM, a ROM, and a hard disk.

27. The terminal of claim 21, wherein the message transmitting module transmits the log information when a particular event including turn-off of the computer occurs.

28. The terminal of claim 21, wherein the terminal is coupled to a peripheral device of the computer including a mouse.

29. The terminal of claim 21, wherein the partial function of the monitor/control program including prevention of lock release, prevention of deleting the monitor/control program, and automatic recovery of the deleted monitor/control program is achieved by a peripheral device including a computer card.
